(19) United States
(12) Patent Application Publication
(10) Pub. No.: US 2025/0259305 A1
(43) Pub. Date: Aug. 14, 2025

(54) Enhanced Platen for Pharmaceutical Compounding

(71) Applicant: Becton, Dickinson and Company, Franklin Lakes, NJ (US)

(72) Inventors: Christian Sandmann, Wayne, NJ (US); Erik Kurt Witt, Oakland, NJ (US)

(21) Appl. No.: 19/196,044

(22) Filed: May 1, 2025

Related U.S. Application Data
(63) Continuation of application No. 17/989,352, filed on Nov. 17, 2022, now Pat. No. 12,315,156.
Application No. 17/989,352 is a continuation of application No. 17/102,777, filed on Nov. 24, 2020, now Pat. No. 11,568,537.
Application No. 17/102,777 is a continuation of application No. 14/847,552, filed on Sep. 8, 2015, now Pat. No. 10,853,938.
(60) Provisional application No. 62/047,325, filed on Sep. 8, 2014.
(60) Provisional application No. 62/072,160, filed on Oct. 29, 2014.
(60) Provisional application No. 62/072,054, filed on Oct. 29, 2014.
(60) Provisional application No. 62/078,067, filed on Nov. 11, 2014.
(60) Provisional application No. 62/077,968, filed on Nov. 11, 2014.

(51) Int. Cl. G06T 7/00; G01G 19/00; G01G 21/28; G05B 19/4155; G06F 3/04817; G06F 3/0482; G06F 3/04842; G06V 20/80; H04N 23/00; H04N 23/51; H04N 23/56; H04N 23/80

(52) U.S. Cl. CPC G06T 7/0012; G01G 21/28; G05B 19/4155; G06F 3/04817; G06F 3/0482; G06F 3/04842; G06V 20/80; H04N 23/00; H04N 23/51; H04N 23/56; H04N 23/80; G01G 19/00; G05B 2219/31313; G05B 2219/35113; G06T 2207/10004

(57) ABSTRACT

A system for preparing and administering a prescribed fluidic pharmaceutical compound, such as a chemotherapy compound, includes a scale having a platen. The scale is in communication with a user display for displaying an output of the scale. An image capture device having a field of view for capturing at least one image of an object placed on the platen is provided in communication with the user display for displaying the captured image. The platen may include a visual identifier for identifying a portion of the field of view of the image capture device. The platen may also include a tackifier or absorbent material. The platen may be formed of a light-transmissible material.

### CROSS-REFERENCE TO RELATED APPLICATION

This application is a continuation of U.S. patent application Ser. No. 17/989,352, filed Nov. 17, 2022, entitled “Enhanced Platen for Pharmaceutical Compounding”, which is a continuation of U.S. patent application Ser. No. 17/102,777, filed Nov. 24, 2020, entitled “Enhanced Platen for Pharmaceutical Compounding” (now U.S. Pat. No. 11,568,537), which is a continuation of U.S. patent application Ser. No. 14/847,552, filed Sep. 8, 2015, entitled “Enhanced Platen for Pharmaceutical Compounding” (now U.S. Pat. No. 10,853,938), which claims priority to U.S. Provisional Application Ser. No. 62/047,325, filed Sep. 8, 2014, entitled “Automated Visual Documentation Feature with Minimal User Input”, U.S. Provisional Application Ser. No. 62/072,160, filed Oct. 29, 2014, entitled “Enhanced Pharmacist Review Module for a System for Preparing a Pharmaceutical Compound”, U.S. Provisional Application Ser. No. 62/072,054, filed Oct. 29, 2014, entitled “Aerodynamically Streamlined Enclosure for Input Devices of a Medication Preparation System”, U.S. Provisional Application Ser. No. 62/078,067, filed Nov. 11, 2014, entitled “Aerodynamically Streamlined Enclosure for Input Devices of a Medication Preparation System”, and U.S. Provisional Application No. 62/077,968, filed Nov. 11, 2014, entitled “Enhanced Platen for Pharmaceutical Compounding”, the entire disclosures of each of which are hereby incorporated by reference.

### BACKGROUND OF THE INVENTION

### Field of the Invention

The present invention is generally directed to scale systems and a method for preparing pharmaceutical compounds, such as chemotherapy compounds and, more specifically, to a scale system having an enhanced platen.

### Description of Related Art

Many technical functions involving the preparation of drugs may be performed in a pharmacy by a pharmacy technician or licensed nurse, to be subsequently reviewed by a remote pharmacist. Systems have been developed that utilize gravimetric information, checked by an algorithm, to confirm the preparation of drugs having proper concentration. Scales may be used to gravimetrically ensure that proper drug concentrations are utilized throughout a compounding process. In instances in which the drug to be prepared is a sterile compounded medication, such as a chemotherapy drug or other cytotoxic drug, the drug preparation is often carried out in a flow hood. In these configurations, the scale is typically placed within the flow hood. As space within a flow hood is typically at a premium, a need exists for a scale having enhanced safety features with a minimal footprint within the flow hood.

In addition, the preparation of chemotherapy drugs or other cytotoxic drugs requires that pharmacy technicians wear protective gear, which can often be bulky and cumbersome. Accordingly, a need exists for an enhanced scale which allows for easier usability and enhanced safety features to reduce the risk of user exposure to toxic components of the drug compounding process.

### SUMMARY OF THE INVENTION

In accordance with an aspect of the present invention, a system for sterile compounding includes a scale having a platen. The scale is in communication with a user display for displaying an output of the scale. The system also includes an image capture device having a field of view for capturing at least one image of an object placed on the platen, with the image capture device in communication with the user display for displaying the captured image. The platen includes a visual identifier for identifying a portion of the field of view of the image capture device.

In certain configurations, the image capture device is positioned above the platen. The scale may include a base portion supporting the platen, and the image capture device may be enclosed within a housing supported by a supporting arm connected to the base portion of the scale. The housing may include a barcode scanner having a sensor for detecting a barcode of an object placed on the platen. Optionally, the visual identifier of the platen includes a cross-shaped recess. In certain configurations, a plurality of recessed grooves are defined within the platen. In other configurations, a plurality of protrusions extend from a surface of the platen. Optionally, the platen may be configured for disposal after a single use. In a further configuration, the system further includes a cover disposed over at least a portion of a top surface of the platen, wherein the cover is configured for disposal after a single use.

In accordance with another embodiment of the present invention, a system for sterile compounding includes a scale, having a base portion and a disposable platen supported by the base portion. The scale is in communication with a user display for displaying an output of the scale. The system also includes an image capture device for capturing at least one image of an object placed on the platen, the image capture device in communication with the user display for displaying the captured image. The disposable platen may include an absorbent material for absorbing a liquid used in the sterile compounding process.

In certain configurations, the platen defines a receiving well therein and the absorbent material is provided within the receiving well. Optionally, the platen includes a tackifier.

In accordance with another embodiment of the present invention, a scale for sterile compounding includes a base portion and a platen supported by the base portion, with the platen having a coating layer disposed thereon. The coating layer provides a visual indicator in response to a fluid contacting the coating layer.

In certain configurations, at least a portion of the coating layer changes color in response to a cytotoxic material contacting the coating layer.

In accordance with another embodiment of the present invention, a scale for sterile compounding includes a base portion having an illumination source disposed therein and a platen supported by the base portion. The platen includes a light-transmissible portion for allowing the illumination source to illuminate an object placed on the platen.

In accordance with yet another embodiment of the present invention, a scale for sterile compounding includes a base portion having a barcode scanner disposed therein and a platen supported by the base portion. The platen includes a light-transmissible portion for allowing the barcode scanner to scan a barcode of an object placed on the platen.

In accordance with a further embodiment of the present invention, a system for sterile compounding includes a scale having a platen. The scale is in communication with a user display for displaying an output of the scale. The system also includes an image capture device having a field of view for capturing at least one image of an object placed on the platen. The image capture device is in communication with the user display for displaying the captured image. The platen includes an individual identifier for indicating to a user whether the platen has been used on the scale for a certain use duration.

Optionally, the system requires that a user is prevented from preparing a sterile compounding procedure until a use duration of the platen is confirmed to be within a compliance parameter.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a perspective view of an exemplary pharmacy preparation system for preparing a pharmaceutical compound in accordance with an embodiment of the present invention.

FIG. 2 is a perspective view of the pharmacy preparation system of FIG. 1 in a laminar flow hood having a user interface in accordance with an embodiment of the present invention.

FIG. 3 is an exploded perspective view of a portion of the pharmacy preparation system of FIG. 1 in accordance with an embodiment of the present invention.

FIG. 4 is a perspective view of a scale platen in accordance with an embodiment of the present invention.

FIG. 5 is a top view of the scale platen of FIG. 4 in accordance with an embodiment of the present invention.

FIG. 6 is a cross-sectional side view of a groove of the scale platen of FIG. 4 taken along line D-D of FIG. 5 in accordance with an embodiment of the present invention.

### DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof, shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

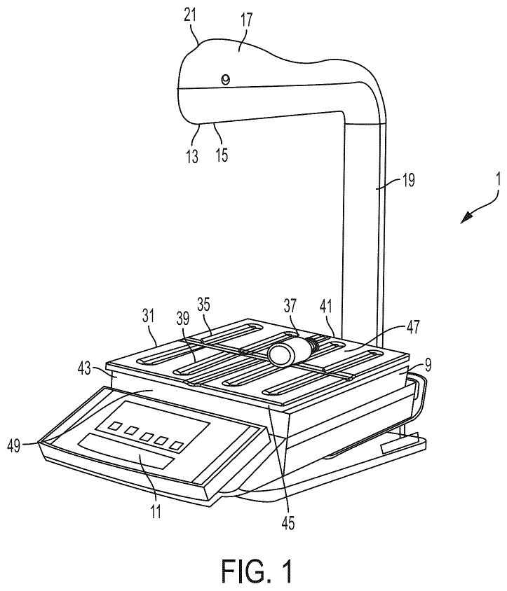

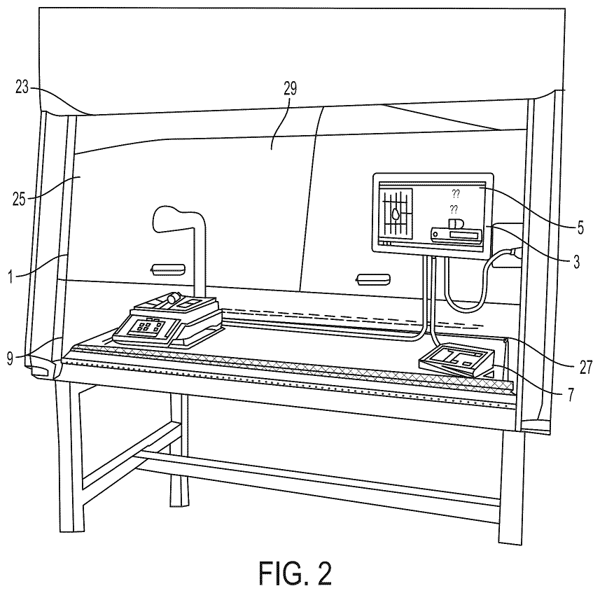

With reference to FIGS. 1-2, a pharmacy preparation system, denoted generally as reference numeral 1, assists pharmacists or non-pharmacist technicians in preparing a syringe, drug vial, or intravenous (IV) bag with one or more prescribed pharmaceutical compounds. The pharmacy preparation system is operatively connected to a user interface 3 including a computer having a processor and a stored memory, as well as a display 5 and a user input device 7, such as a keyboard, mouse, etc. A scale 9 having a scale output interface 11 may be operatively connected to the user interface 3.

In one embodiment, a barcode scanner 13 may be operatively connected to at least one of the user interface 3 and the scale 9, such that the barcode scanner 13 may scan a medication vial having a barcode that is placed onto a portion of the scale 9. In another embodiment, an image capture device 15 may be operatively connected to at least one of the user interface 3 and the scale 9, such that the image capture device 15 may take a picture of an item, such as a medication vial, IV bag, or syringe placed onto a portion of the scale 9. In one embodiment, the image capture device 15 may capture a plurality of still images or running video of items placed onto a portion of the scale 9 throughout the medication compounding process for documentation and/or subsequent review of the medication compounding process.

In still another embodiment, at least one of the barcode scanner 13 and the image capture device 15 may be at least partially enclosed within a housing 17. In certain configurations, the housing 17 may fully enclose the barcode scanner 13 and the image capture device 15. Optionally, the housing 17 may include only one of the barcode scanner 13 and the image capture device 15. In one configuration, the barcode scanner 13 may be positioned within the housing 17 such that the barcode scanner 13 may easily scan a barcode of an item placed onto a portion of the scale 9 without further manipulation by the user. In another configuration, the image capture device 15 may be positioned within the housing 17 such that the image capture device may easily capture images of an item placed onto a portion of the scale 9 without further manipulation by the user.

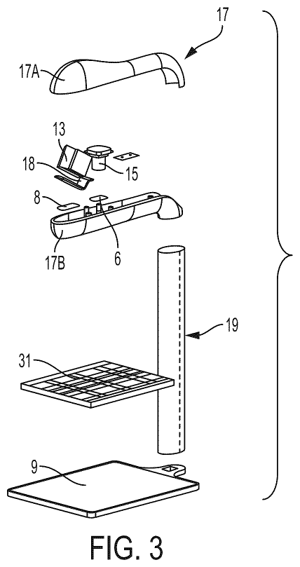

With specific reference to FIG. 3, the housing 17 may be formed of an upper portion 17A and a lower portion 17B which are interfaced to provide minimal surface perturbations to minimize any surface adherence of contaminants such as microbes or other pathogens. In one embodiment, the manufacturing of the housing 17 adheres to U.S. Pat. No. 797. Optical lenses 6, 7 may be fitted with the housing 17 to further ensure adherence to U.S. Pat. No. 797. In one configuration, optical lens 6 may be fitted with housing 17 in optical communication with image capture device 15. In another configuration, optical lens 7 may be fitted with housing 17 in optical communication with barcode scanner 13.

In one configuration, the barcode scanner 13 may be positioned within the housing 17 such that the barcode scanner 13 has a scanner that is offset from immediately scanning a barcode of an item placed onto a portion of the scale 9 without further manipulation by the user. In this configuration, accidental scanning is avoided. As shown in FIG. 3, the barcode scanner 13 may be positioned such that the sensor is angled with respect to a platen 31 of the scale, such as at a 45° angle by a mounting bracket 18. In this configuration, the user must actively place the objects to be scanned in range of the sensor of the barcode scanner 13. In another configuration, the image capture device 15 may be positioned within the housing 17 such that the image capture device may easily capture images of an item placed onto a portion of the scale 9 without further manipulation by the user.

The housing 17 may be positioned above a portion of the scale 9, such as supported by a supporting arm 19. As shown in FIG. 2, the pharmacy preparation system 1 may be positioned within a laminar flow hood 25 having an inlet air source 23 and an outlet air port 27 for creating a laminar flow of air within an interior 29 of the laminar flow hood 25. An exterior surface 21 of the housing 17 may have a shape and/or profile which is optimized to reduce disruption of the flow of air within the laminar flow hood 25.

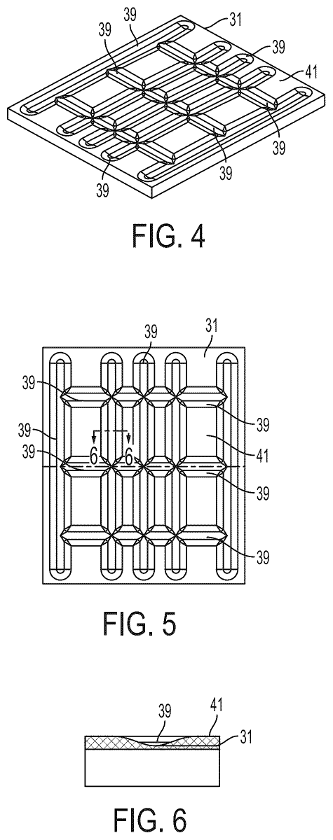

Referring again to FIGS. 1-3, the scale 9 may include a base portion 43 which supports a platen 31 thereon. The scale 9 may be implemented as any suitable device for detecting a change in mass or weight when an object is placed thereon. Accordingly, the scale 9 may be simply configured as a device that sends a signal when the mass or weight of an object is greater or less than a predetermined threshold or as a high-precision scale that provides an accurate reading of the weight of an object placed thereon. Optionally, the base portion 43 houses a strain gauge load cell which measures the strain of an object placed on the platen 31, and a force transducer, such as a load cell sensor, which converts the force applied to the platen 31 into an electrical signal which may be relayed to the scale output interface 11. The base portion 43 supports the platen 31, such as a portion of the weighing surface of the scale 9, which may provide a visual indication, such as a cross recess 35, to the technician of a center, or other desired portion, of an image to be captured by the image capture device 15. This allows a technician to properly position drug compounding related medications 37 and related supplies within the field of view of the image capture device 15, such as the image capture device enclosed within the housing 17 positioned above the platen 31 of the scale 9. In one configuration, as shown in FIGS. 4-6, an upper surface 41 of the platen 31 may define a plurality of recessed grooves 39 and/or protrusions extending from a surface of the platen 31 to frictionally restrain drug compounding related medications 37 and related supplies on the upper surface 41 of the platen 31. In another configuration, the upper surface 41 of the platen 31 may include a tackifier or other frictionally enhancing surface to similarly restrain drug compounding related medications 37 and related supplies on the upper surface 41 of the platen 31. The arrangement of grooves 39 and/or protrusions may easily indicate to a user the center of the platen 31 which may be arranged to coincide with the center of the field of view of the image capture device 15.

The plurality of recessed grooves 39 and/or protrusions extending from a surface of the platen 31 may be configured to restrain any liquid material that is accidentally spilled on the upper surface 41 of the platen 31 during a compounding procedure. The plurality of recessed grooves 39 may define a receiving well 47 which serves to collect and restrain accidentally spilled material in a confined area within the platen 31 until proper disposal techniques may be employed. The surface of the platen 31 may be coated with a durable composition that resists degradation caused by exposure to caustic agents, such as chemotherapy compounds and drugs, as well as cleaning agents, such as bleach, isopropyl alcohol, and the like. In certain configurations, the durable composition may be an epoxy or epoxy-based paint or coating.

In another embodiment, the platen 31 may be removable from a base unit 43 of the scale 9. In this configuration, the platen 31 may be disposable and a technician may remove and dispose of the platen 31 after a single sterile drug compounding procedure. In this configuration, calibration of the scale 9 may be required for each individual platen 31 that is engaged with the base 43. In an alternative configuration, the platen 31 may include a disposable cover layer which may be removed and disposed of after a sterile drug compounding procedure. The disposable aspect of the platen 31 ensures that prior to each compounding procedure, the platen 31 is clean and that no contaminates may transfer to a component of the drug compounding procedure. The platen 31 may be formed of a metal, composite, or polymeric material, as is conventionally known for scale weighing surfaces. In a further configuration, each platen 31 and/or disposable cover layer, may include a unique individual identifier 45, embedded therein or attached to a surface thereof, which may be captured in an image captured by the image capture device 15. This allows for a technician and/or subsequent reviewer of the images captured by the image capture device 15 of the drug compounding procedure to verify that the platen 31 was changed between preparations. This may provide documented proof of a technician's compliance with institutional safety and sterility requirements. In certain configurations, the individual identifier 45 may be detected by the system software to determine whether the platen 31 has been replaced at a specified interval, for example, at a specified point during a shift, a day, a preparation and/or after contamination is detected. In a further configuration, the need for a user to change the platen 31 may be shown through the user interface 3, such as through a GUI. In a further configuration, the system may include safety features such that the user may be prevented from performing a compounding procedure until the platen 31 is replaced. A user may be prevented from preparing a sterile compounding procedure using the scale 9 and the platen 31 until the use duration of the platen 31 is confirmed to be within a compliance parameter.

In a further embodiment, the platen 31 may include an absorbent material which may absorb accidentally spilled material until proper disposal techniques may be employed. In a further configuration, at least one receiving well 47 of the platen 31 may include the absorbent material therein.

In certain situations, such as an aerosolation, it may be difficult for a technician to determine whether a cytotoxic material has been accidentally released from a container. Accordingly, the upper surface 41 of the platen 31 may include a coating layer which provides a visual indication, such as a color change, in response to fluid contacting the coating layer. In one configuration, the coating layer provides a visual indication in response to a leak or unintentional spill of material on the coating layer of the platen 31. The coating layer may be configured to provide a color change upon contact with a cytotoxic material. The visual indication may be visually observable to a technician or user of the system. In other configurations, the visual indication may be observable by the image capture device 15, or additional image capture device, such as an infrared camera.

In a further configuration, the platen 31 may be formed of a transparent and/or translucent material which permits passage of light therethrough. In this configuration, the base portion 43 of the scale 9 may also include a light source 49 for illuminating a portion of the platen 31, such as by passing light through the platen 31 from a location underneath the platen 31. This allows for enhanced visual inspection of drug compounding related medications 37 and related supplies to ensure they are free of defects. For example, the illuminated platen 31 may allow for a technician to visualize coring found in fluid filled IV bags. The light source 49 may be tuned to a certain wavelength appropriate to illuminate certain particles present within the drug compounding related medications 37. In a certain configuration, the platen 31 may include regions that are opaque or substantially opaque and regions that are transparent, substantially transparent, translucent, and/or substantially translucent in order to selectively allow for illumination of certain portions of the platen 31.

In another configuration, a scanner may be housed within the base portion 43 of the scale 9. The scanner may be a barcode scanner optically configured to scan barcode labels present on drug compounding related medications 37 through the translucent and/or transparent portions of the platen 31. The barcode scanner may be configured to obtain information from the barcodes to determine the contents of the vials placed on the platen 31. In a further configuration, a barcode writer or an integrated label printer may be positioned within the base portion 43 of the scale 9 to write information to the label of a drug compounding related medication 37 placed on the platen 31. In one configuration, the barcode writer may be configured to write information to the label of a drug compounding medication 37 pertaining to compounding results, date, time, lot numbers, and the like.

In yet a further configuration, the platen 31 may be in wireless communication with one or more system components. For example, a wireless interface may be provided in electrical communication with the platen 31 which may read and/or write data to a device provided on top of the platen 31. The wireless interface may be a Bluetooth connection to a pump connected to a drug vessel provided on the platen 31. Information transferred thereby may include pump operating parameters, such as patient specific flow rate and volumes. Accordingly, an automatically programmed device may be provided without requiring further user handling steps.

In yet a further configuration, the platen 31 may be configured to exhibit a visual indicator, such as a color change, when a weight measured by the scale 9 is within a specified tolerance. For example, the platen 31 may be equipped with an illuminated display which is activated once the scale 9 is stabilized and the unit measured is within a specified tolerance for a given drug compounding process.

In operation, the pharmacist/technician may be prompted through a series of display screens provided on the display of the user interface 3 to take the following steps. First, the operator may scan a first barcode with the barcode scanner 13 on a drug compounding related medication 37 including a drug to be reconstituted to prepare the prescribed pharmaceutical compound. The medication container may be placed on the scale 9 at the time of the scan, or a user may first scan the barcode and subsequently place the drug compounding related medication 37 on the platen 31 of the scale 9. Once the weight stabilizes, the system verifies, using a mathematical algorithm, that the measured weight is meeting the weight target plus/minus a predetermined tolerance. In addition, the image capture device 15 takes an image of the drug compounding related medication 37 and displays it to the user on the display of the user interface 3. The user then removes the drug compounding related medication 37 from the platen 31 and the image is saved to the data record of the drug preparation. If the system cannot verify that the measured weight is within that target weight tolerance, the technician is required to re-perform this step until the correct weight is achieved.

Next, the technician scans a second barcode of a fluid container of fluid that is to be mixed with the drug to be reconstituted. As discussed above, the medication container containing the fluid may be placed on the scale 9 at the time of the scan, or a user may first scan the barcode and subsequently place the drug compounding related medication 37 on the platen 31 of the scale 9. Once the weight stabilizes, the image capture device 15 takes an image of the drug compounding related medication 37 and displays it to the user on the display of the user interface 3. The user then removes the drug compounding related medication 37 and the image is saved to the data record of the drug preparation. Again, if the system cannot verify that the measured weight is within that target weight tolerance, the technician is required to re-perform this step until the correct weight is achieved.

Thereafter, the user mixes the drug to be reconstituted with the fluid in the fluid container, both drug compounding related medications 37, by injecting the fluid from the fluid container into the medication container. The medication container is then returned to the platen 31 of the scale 9 and the weight of the medication container is verified. Once the weight is stabilized and verified, the image capture device 15 automatically takes an image of the completed drug compounding related medication 37 based on a signal received from the scale and displays the image on the display of the user interface 3. If the system cannot verify that the measured weight is within that target weight tolerance, the technician is required to re-perform this step until the correct weight is achieved.

If the technician decides that any of the above-described images are not meeting certain requirements, there is the option to request a new or additional image. Requesting another picture may automatically switch the image capture device 15 into a “live video mode” displayed at the user interface 3. The technician can now move the medication container on the scale 9 to a preferred position and trigger the image capture through the user interface 3. As before, the captured image will be shown at the user interface 3 and by removing the item from the scale 9, the technician accepts the image and the system automatically moves to the next compounding step.

Once the drug preparation is complete, the system may optionally print a barcode label for placement on the completed drug preparation that includes encoded information representing the name of the pharmaceutical and patient information.

The pharmacy preparation system 1 may function in conjunction with several sequential computer-implemented modules for preparing and administering a prescribed fluidic compound, such as a chemotherapy compound. The modules each include code allowing for input from a user, generating output, and calculating and determining instructions for the preparation and administration of the pharmaceutical compound that may be implemented on one or more processors. More specifically, the modules may allow for a physician to enter a prescription for a patient that is subsequently verified for accuracy, prepared based on computer-aided instruction, verified based on a weight measurement, and administered to a patient. The modules may, during the drug preparation: (i) retrieve the prescription information data input by the physician in the CPOE module from the intra-hospital network; (ii) verify that the scanned barcode corresponds with the prescription information; (iii) determine if the weight of the syringe and/or IV bag is within a predetermined threshold accuracy level for the amount of the pharmaceutical to be administered; (iv) determine what adjustments must be made if the weight is not accurate; and (v) transmit data relating to the weight of the syringe and/or IV bag back to the intra-hospital network. These modules and processes may be implemented on several networked computing devices, or an independent computing device having its own processor where data and information is communicated between the computing devices using any suitable wired or wireless communication protocol, such as, but not limited to Ethernet, WiFi, cellular, Bluetooth, or the like.

Accordingly, the present invention guides a pharmacist or technician through the different compounding steps to prepare a medication order in a pharmacy by giving step-by-step instructions on a computer screen and verifying the different compounding steps by measuring the weight of the compounded liquids with a scale. The measured weight is then analyzed with a mathematical algorithm which checks if the necessary compounding accuracy has been accomplished. Every time an item is placed on the scale, a picture of the top of the scale is captured to create a visual documentation trail of the compounding process. The pictures are stored together with the recorded measurements from the scale and the algorithm result in a log file. If a measured weight of a drug is not in the predefined tolerance range of the expected weight, the software generates instructions to change the amount of the drug to bring it within the acceptable tolerance range. The software will not proceed to the next compounding step as long as the required tolerance of the present step has not been accomplished.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A scale for sterile compounding, comprising:
a base portion having an illumination source coupled thereto; and
a platen supported by the base portion, the platen comprising a light-transmissible portion configured to allow the illumination source to illuminate an object placed on the platen,
wherein the illumination source is configured to illuminate the light-transmissible portion with a visual indicator when a weight measured by the scale is within a target weight tolerance range.

2. The scale of claim 1, wherein the platen further comprises a visual identifier configured to identify a center of the platen.

3. The scale of claim 1, wherein the platen further comprises one or more grooves in an upper surface thereof.

4. The scale of claim 1, wherein the platen is configured to be disposable.

5. The scale of claim 4, wherein the platen further comprises an absorbent material configured to absorb a liquid that contacts the platen.

6. The scale of claim 1, wherein the platen further comprises a cover disposed over at least a portion of an upper surface thereof, and wherein the cover is configured to be disposable.

7. The scale of claim 1, wherein the platen further comprises a coating layer configured to indicate that a fluid has contacted the coating layer.

8. The scale of claim 1, wherein the visual indicator comprises a change in color to the light-transmissible portion.

9. The scale of claim 1, wherein the base portion further comprises a barcode scanner arranged therein.

10. A system for sterile compounding, comprising:
a scale comprising:
a base portion having an illumination source disposed therein; and
a platen supported by the base portion, the platen comprising a light-transmissible portion configured to allow the illumination source to illuminate an object placed on the platen;
a housing including an image capture device therein, the image capture device having a field of view for capturing at least one image of an object placed on the platen; and
a user display in communication with the image capture device, the user display configured to display information relating to the object,
wherein the illumination source is configured to illuminate the light-transmissible portion with a visual indicator when a weight measured by the scale is within a target weight tolerance range.

11. The system of claim 10, wherein the platen further comprises a visual identifier configured to identify a center of a field of view of the image capture device.

12. The system of claim 10, wherein the platen further comprises one or more grooves in an upper surface thereof.

13. The system of claim 10, wherein the platen is configured to be disposable.

14. The system of claim 13, wherein the platen further comprises an absorbent material configured to absorb a liquid that contacts the platen.

15. The system of claim 10, wherein the platen further comprises a cover disposed over at least a portion of an upper surface thereof, and wherein the cover is configured to be disposable.

16. The system of claim 10, wherein the platen further comprises a coating layer configured to indicate that a fluid has contacted the coating layer.

17. The system of claim 10, wherein the visual indicator comprises a change in color to the light-transmissible portion.

18. The system of claim 10, wherein the image capture device comprises a barcode scanner.

19. A platen for a scale for sterile pharmaceutical compounding, the platen comprising:
a support to engage with a top surface of the scale; and
a light-transmissible portion configured to allow light from an illumination source to illuminate an object placed on the platen from below,
wherein the light-transmissible portion is configured to be illuminated with a visual indicator by the illumination source when a weight measured by the scale is within a target weight tolerance range.

20. The platen of claim 19, wherein the visual indicator comprises a change in color to the light-transmissible portion.
